(19) United States
(12) Patent Application Publication
(10) Pub. No.: US 2006/0235686 A1
(43) Pub. Date: Oct. 19, 2006

(54) Speech recognition device

(75) Inventors: Hong Jeong, Pohang-City (KR); Yong Kim, Pohang-City (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: POSTECH FOUNDATION, Pohang-city (KR)

(21) Appl. No.: 11/262,167

(22) Filed: Oct. 28, 2005

(30) Foreign Application Priority Data
Apr. 14, 2005 (KR) 10-2005-0031127

(51) Int. Cl. G10L 15/00

(52) U.S. Cl. 704/238

(57) ABSTRACT

Disclosed is a speech recognition device using a hidden Markov model and a two-level dynamic programming scheme. The speech recognition device includes an analog to digital converter for sampling and quantizing speech signals into digital speech signals; a noise eliminator for reducing noise from the digital speech signals; a feature vector generator for generating a feature vector from the noise-eliminated speech signals, and converting the feature vector into a test pattern; and a processor including a plurality of processing elements arranged in parallel, each processing element calculating a matching cost of a test pattern and a reference pattern, selecting the minimum value from among the calculated matching costs, and outputting the minimum value as the minimum matching cost of an input test pattern.

### CROSS-REFERENCE TO RELATED APPLICATION

This application claims priority to and the benefit of Korean Patent Application 10-2005-0031127 filed in the Korean Intellectual Property Office on Apr. 14, 2005, the entire content of which is incorporated herein by reference.

### BACKGROUND OF THE INVENTION

1. Field of the Invention

The present invention relates to a speech recognition device using a hidden Markov model and a two-level dynamic programming scheme.

2. Description of the Related Art

Speech recognition is a process for a computer to map acoustic speech signals to text. That is, speech recognition represents a process for converting acoustic speech signals provided by a microphone or a telephone into words, a group of words, or sentences. Recognition results may be used as final results to application fields such as instructions, controls, data inputs, and documentation, and may also be used as inputs of language processing to the field of speech understanding. Further, speech recognition is an essential technique for allowing interactive communication between people and computers, making the computer usage environments more convenient for people, and thereby enhancing their lifestyle.

A general speech recognition method matches a plurality of reference patterns that are prestored in correspondence to the words to be recognized with test patterns that are patterned for the matching of speech signals to be recognized, and recognizes the word that corresponds to the reference pattern that is determined to be the most appropriate matched one to be the input speech signal.

The methods for finding the most appropriate matched reference pattern includes the hidden Markov model (HMM) that uses a statistical modeling scheme to find the desired word, the time delay neural network (TDNN), and dynamic time warping (DTW) that finds the optimized reference pattern in an efficient manner when a difference of temporal length between the test pattern and the reference pattern may exist.

In the above-described prior art for finding the optimized reference pattern, a speech recognition program is installed in the computer, and speech recognition is performed by operating the computer.

Therefore, it has been required to provide a speech recognition device that implements the speech recognition program for matching the test patterns with the reference patterns in a hardwired manner, and thereby allow high-speed speech recognition rates and a lesser size thereof. Also, the existing hardwared devices recognize speech word by word, and hence, are limited to the isolated word recognition devices that allow word-based learning and recognition.

The above information disclosed in this Background section is only for enhancement of understanding of the background of the invention, and therefore it may contain information that does not form the prior art that is already known in this country to a person or ordinary skill in the art.

### SUMMARY OF THE INVENTION

The present invention has been made in an effort to provide a speech recognition device having advantages of allowing real-time speech recognition and mass production using an application-specific integrated circuit (ASIC) having a small chip size.

An exemplary speech recognition device according to an embodiment of the present invention includes an analog to digital (A/D) converter, a noise eliminator, a feature vector generator, and a processor. The A/D converter samples and quantizes speech signals into digital speech signals. The noise eliminator reduces the noise from the digital speech signals. The feature vector generator generates a feature vector from the noise-eliminated speech signals and converts the feature vector into a test pattern. The processor includes a plurality of processing elements arranged in parallel, and each processing element calculates a matching cost of a test pattern due to the discordance of the test pattern and a reference pattern. The processor selects the minimum value among the matching costs calculated by the plurality of processing elements, and outputs the minimum value as the minimum matching cost of an input test pattern. The processor comprises a memory module and a pattern match module. The memory module stores a plurality of reference patterns corresponding to a plurality of words, and sequentially outputs characteristic vectors included in the reference patterns for calculating matching costs. The pattern match module includes at least one processing element group having a plurality of processing elements arranged in parallel, and it calculates a minimum matching cost for a test pattern and extracts an index of a corresponding reference pattern.

In a further embodiment, a speech recognition device for finding a reference pattern corresponding to a test pattern, provided by a speech signal, having the minimum matching cost comprises a feature vector generator and a processor. The feature vector generator generates a feature vector from noise-eliminated speech signals, and converts the feature vector into a test pattern for speech recognition. The processor includes a memory module for storing a plurality of reference patterns corresponding to a plurality of words and sequentially outputting the feature vector included in the reference patterns, and includes a plurality of processing elements arranged in parallel each of which calculates a matching cost of a test pattern due to the discordance of the test pattern and a reference pattern, selects the minimum one from among the calculated matching costs, and outputs the minimum one as the minimum matching cost for a test pattern.

### BRIEF DESCRIPTION OF THE DRAWINGS

FIG. 1 shows a block diagram for a speech recognition device according to an exemplary embodiment of the present invention.

FIG. 2 shows a detailed block diagram of a component shown in FIG. 1.

FIG. 3 shows a first level of a pattern match module according to the exemplary embodiment of the present invention.

FIG. 4 shows a hidden Markov algorithm applied to the embodiment of the present invention.

FIG. 5 shows a comparison module of the pattern match module according to the exemplary embodiment of the present invention.

FIG. 6 shows an algorithm applied to a second level of the pattern match module according to the exemplary embodiment of the present invention.

FIG. 7 shows a second level of the pattern match module according to the exemplary embodiment of the present invention.

FIG. 8 shows a processing element of the second level according to the exemplary embodiment of the present invention.

### DETAILED DESCRIPTION OF THE EMBODIMENTS

An embodiment of the present invention will hereinafter be described in detail with reference to the accompanying drawings.

In the following detailed description, only certain exemplary embodiments of the present invention have been shown and described, simply by way of illustration. The present invention may have other exemplary embodiments in addition to the embodiment to be described. Accordingly, the drawings and description are to be regarded as illustrative in nature and not restrictive. Similar reference numerals are provided to similar parts over the specification. To couple a first part to a second part includes the case in which the first and second parts are directly coupled and the case in which they are coupled with a third part between them.

The speech recognition device according to the embodiment of the present invention may be implemented in a hardwired manner on a communication chip with high data rates, and is applicable to hardware implemented as a very large scale integration (VLSI) chip. In particular, the present invention relates to a chip design technique based on the ASIC and FPGA, and allows realization of small devices with lower power consumption and low costs by developing an algorithm optimized to the chip. Hardwired realization of the speech recognition system allows easy installation in a device that uses speech recognition through a small and convenient interface without a computer, and allows real-time speech recognition owing to very fast performance and the parallel architecture.

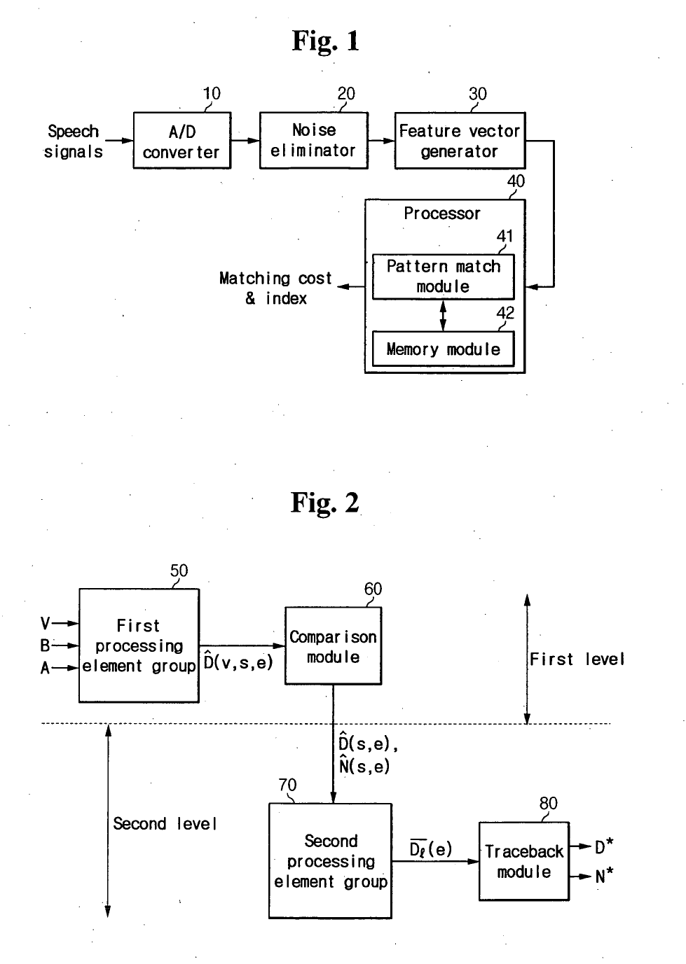

FIG. 1 shows a block diagram for a speech recognition device according to an exemplary embodiment of the present invention. As shown in FIG. 1, the speech recognition device includes an A/D converter 10, a noise eliminator 20, a feature vector generator 30, and a processor 40 that includes a pattern match module 41 and a memory 42.

The A/D converter 10 converts analog speech signals into digital speech signals through sampling and quantization.

The noise eliminator 20 reduces background noise or white noise that may be provided in the analog input signals or may be generated during quantization so as to increase the recognition rate of the speech signals quantized by the A/D converter, and then transmits digital speech signals to the feature vector generator 30.

The feature vector generator 30 generates a feature vector for patterning the digital speech signals, converts the generated feature vector into a test pattern, and transmits the test pattern to the processor 40. However, the number of feature vectors of the test patterns generated from the speech signals for the matching with the reference pattern may be determined by a speech recognition chip designer.

The processor 40, configured based on two-level dynamic programming (TLDP), outputs speech recognition results which are obtained by applying the hidden Markov model (HMM) that has random variables predefined through learning as parameters to the test pattern of the feature vector transmitted by the feature vector generator 30. That is, the processor 40 finds a reference pattern that mostly matches the test pattern by using the information of reference patterns stored in a memory 42 in the processor 40, and extracts an index of the corresponding word.

FIG. 2 shows a detailed configuration of the pattern match moduel 41 in the processor 40 of the speech recognition device shown in FIG. 1 and a flow of data processed by respective components.

The pattern match module 41 calculates the minimum matching cost of a test pattern in comparison with reference patterns through the TLDP, and extracts a corresponding index of the reference pattern which has the minimum matching cost.

As shown in FIG. 2, the pattern match module 41 includes a first processing element group 50, a comparison module 60, a second processing element group 70, and a traceback module 80.

The first processing element group 50 includes a plurality of processing elements that have the same configuration, are arranged in parallel, and respectively calculate matching costs by using the hidden Markov algorithm.

The comparison module 60 determines the minimum one from among the matching costs calculated by the processing elements forming the first processing element group 50, and stores the determined minimum one for later calculation.

The second processing element group 70 finds the optimized matching cost with the reference pattern for the total frame by using the minimum value determined by the comparison module 60, detects the word's end point, and recognizes a connected word. The second processing element group 70 includes a plurality of processing elements having the same configuration and being arranged in parallel.

The traceback module 80 finds a word arrangement of the reference pattern that corresponds to the speech recognition result based on the calculation result by the second processing element group 70.

In this instance, the first processing element group 50 and the comparison module 60 form a first level, the second processing element group 70 and the traceback module 80 form a second level.

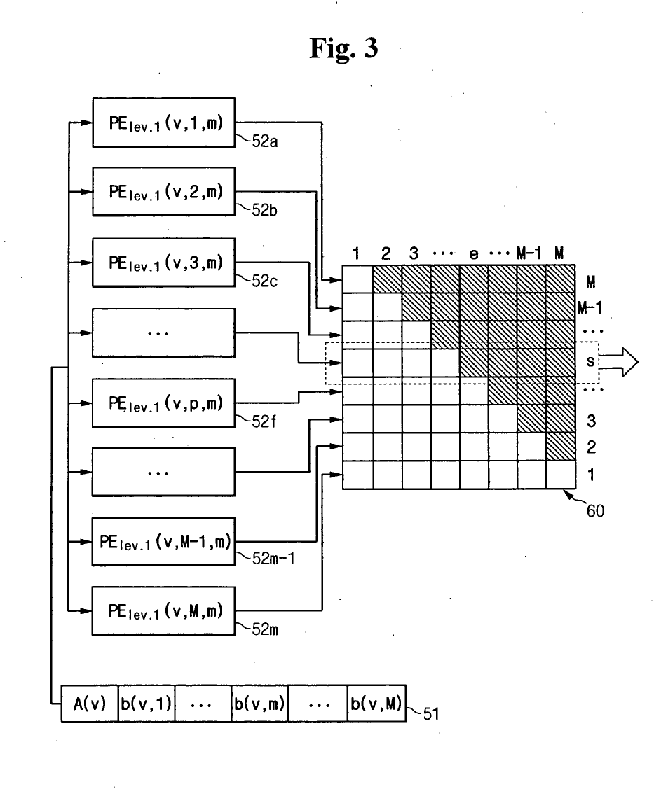

FIG. 3 shows the first level of the pattern match module 41 according to the exemplary embodiment of the present invention. As shown in FIG. 2 and FIG. 3, the first level includes the first processing element group 50 and the comparison module 60, and the first processing element group 50 includes a state input unit 51 and a plurality of processing elements 52a to 52m that have the same configuration for calculating the matching cost and are arranged in parallel.

The above-configured first level calculates matching costs of a test pattern in comparison with reference patterns at a start point and an end point by using the hidden Markov algorithm and the dynamic programming scheme, determines the minimum matching cost among the calculated matching costs, and extracts an index of the reference pattern corresponding to the minimum matching cost. That is, since the start points for comparing the test pattern and the reference pattern for calculating the matching costs by applying the dynamic programming scheme to the respective processing elements are established to have different values, matching costs having the respective components as start points may be calculated by using M input clock signals when the test pattern has M components.

When the state input unit 51 receives a feature vector of a speech signal from the feature vector generator 30, parameters A and B that are hidden Markov model parameters are calculated according to the learned probabilistic value, and are provided to the state input unit 51. To calculate matching costs, the hidden Markov model parameters are sequentially input to the processing elements 52a to 52m as clock signals.

The above-noted hidden Markov model for calculating the matching costs now will be described.

The hidden Markov model represents a method for finding probabilistic parameters of the Markov model and generating a reference Markov model by using a speech corpus during the learning process, and recognizing speech by selecting the reference Markov model that is the most similar to the input speech in the recognition process on the assumption that the speech signal may be Markov-modeled. The hidden Markov model represents a set of concatenated states according to state transition, each transition relates to a transition probability for controlling state changes, and an observation probability for defining conditional probability is provided by each observation symbol from a predetermined number of observation targets when a transition is performed. Parameters for the speech recognition process using the hidden Markov model are given below.
1) N is a value for representing the number of states of the hidden Markov model, and a set of each state is defined to be Q={q₁, q₂, . . . , q_{N}}, and the state at the time of t is defined to be qₜ.
2) M is a value for representing the number of observation symbols, and a set of each symbol is defined to be V={v₁, v₂, . . . , v_{M}}.
3) T is a value for indicating the length of an observation sequence.
4) O={o₁, o₂, . . . , o_{T}} represents an observation sequence.
5) A={aᵢⱼ} is a state transition probability where aᵢⱼ=P[qₜ₊₁=j|qₜ=i], (1≦k≦M).
6) B={bⱼ(k)} is a state observation probability where bⱼ(k)=P[oₜ=vₖ|qₜ=j], (1≦k≦M)
7) Θ={πᵢ} is an initial state probability where πᵢ=P[qₜ=i], (1≦i≦N).

The hidden Markov model using the parameters 1) to 7) may be simplified as λ=(A, B, π), and performs speech recognition to solve the problems of i) probability estimation, ii) finding a hidden state sequence, and iii) learning.

First, the problem of probability estimation is to evaluate the probability of outputting the observation sequence O for the model λ by using a forward algorithm when the model parameter λ=(A, B, π) and the observation sequence O={o₁, o₂, . . . , o_{T}} are given.

Second, the problem of finding a hidden state sequence corresponds to a decoding process, and is to find the optimized state sequence Q={q₁, q₂, . . . , q_{N}} by using the Viterbi algorithm and finding a path for the model P(O|λ) having the highest probability p(Q, O|λ) when the model λ=(A, B, π) and the observation sequence O={o₁, o₂, . . . , o_{T}} are given.

Third, the problem of learning is to control the parameter of the model λ by using the Baum-Welch algorithm so as to maximize the probability P(O|λ) of outputting the observation sequence O={o₁, o₂, . . . , o_{T}} for the model λ=(A, B, π).

The pattern match module realizes the estimation problem and the decoding problem in a hardwired manner, and realizes the learning problem in a software manner.

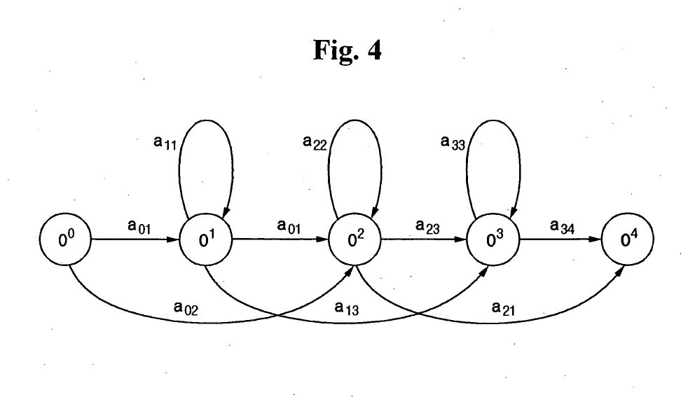

FIG. 4 shows a schematic diagram for the hidden Markov model algorithm. The states of transition probability of the hidden Markov model do not go backward and do not change greatly since the speech proceeds as time goes, and hence, the left-to-right model shown in FIG. 4 is used on the assumption that the states have the characteristic of proceeding from the left to the right.

The respective processing elements forming the first processing element group 50 using the hidden Markov model and the dynamic programming scheme calculate matching costs according to the hidden Markov algorithm, and for example, the matching cost PEₗₑᵥ₁ (v, p, m) at the p-th processing element 52p is given in Equation 1.

$$\begin{matrix}{PE}_{leυ 1} ( υ , p = s , m = e ) = \hat{D} ( υ , s , e ) \\ = {min}_{w ( m )} {\sum }_{m = s}^{e} ‖ \vec{t} ( m ) - {\vec{r}}_{υ} ( w ( m ) ) ‖\end{matrix} \qquad ( Equation 1 )$$

where s(1≦s≦M) is a start point of a test pattern, e(1≦e≦M, e<s) is an end point, t is a test pattern, τᵥ(1≦v≦V) is a pattern of the v-th word from among V reference patterns to be recognized, w(m) is a window for dividing the total frame input for signal analysis during a very short time that is assumed to be stable, and M is the dimension of the total frame. Equation 1 shows a matching cost between the test pattern and the reference pattern during the interval of (s,e).

As can be known from Equation 1, the p-th processing element sequentially calculates matching costs from p to M when the start point is given to be p. The number of above-functioned processing elements is given to be M, and hence, the matching costs from all the start points to all the end points can be calculated. Therefore, realization of the above process in the software manner requires the matching time of M² clock signals, and realization thereof in the parallel hardwired configuration manner according to the exemplary embodiment of the present invention generates the same calculation results by using M clock signals corresponding to the dimension of the total frame.

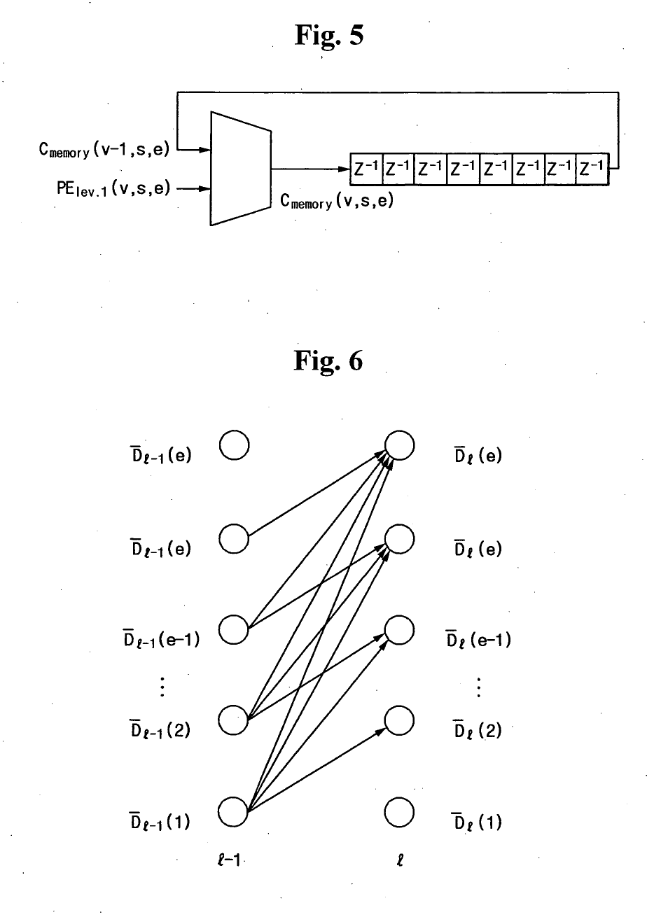

FIG. 5 shows a detailed comparison module 60 of FIG. 3. The comparison module 60 stores the minimum value of the M matching costs PEₗₑᵥ₁ (v, s, e) calculated by the first processing element group 50, and stores an index that corresponds to the reference pattern in this instance and is extracted from the memory 42, and the calculation of the minimum matching cost is given in Equation 2.
C_{memory}=(v, s, e)=min[|C_{memory}(v−1, s, e), PE_{;ev1} (v, s, e)] (Equation 2)

wherein, C_{memory}(v, s, e) is a matching cost stored in the memory.

As can be known from Equation 2, the minimum matching cost C_{memory}(v−1, s, e) that is input and prestored in the memory is compared to the current input matching cost PEₗₑᵥ₁(v, s, e), and the lesser one is stored in the memory. That is, the minimum one from among the matching costs that are input up to a specific time is stored in the memory. In this instance, since the values of e in PEₗₑᵥ₁(v, s, e) are sequentially input from 1 to M, the memory in the comparison module 60 is configured to have M first-input first-output (FIFO) memories for sequential comparative calculation, and as shown in FIG. 3, the vertical axis stores the cost of the start point and the horizontal axis stores the cost of the end point. In this instance, since the start point cannot be greater than the end point, the available values correspond to those with slash marks in the comparison module 60 of FIG. 3

In this instance, the comparison module 60 stores the minimum matching cost and a corresponding index. The index is found using Equation 3.
I(v, s, e)=arg min[C_{memory}(v−1, s, e), PE_{leτ1} (v, s, e)] (Equation 3)

When matching with the V reference patterns stored in the memory module 42 is finished, the value to be stored in the comparison module 60 is given in Equation 4 and Equation 5.

$$\begin{matrix}\tilde{D} ( s , e ) = {min}_{1 \leq υ \leq V} [ \hat{D} ( υ , s , e ) ] & ( Equation 4 ) \\ \tilde{N} ( s , e ) = arg {min}_{1 \leq υ \leq V} [ \hat{D} ( υ , s , e ) ] & ( Equation 5 )\end{matrix}$$

That is, \tilde{D}(s, e) is a matching cost with the reference pattern that matches a specific test the most, and Ñ(s, e) is an index of a corresponding reference pattern. The second level determines a word arrangement that matches the frame by using the calculated matching cost and the index. It is determined by the matching process to check how many words the total frame has.

FIG. 6 shows an algorithm for finding the optimized matching cost in the second level. In detail, FIG. 6 illustrates an algorithm for finding the optimized matching cost \overline{D}ₗ(e) with I reference patterns for ‘e’ test patterns that are generated by extracting a feature vector from the input speech signal, and \overline{D}ₗ(e) is defined in Equation 6.

$${\overline{D}}_{l} ( e ) = {min}_{1 \leq s < e} [ \tilde{D} ( s , e ) + {\overline{D}}_{l - 1} ( s - 1 ) ] \qquad ( Equation 6 )$$

As shown in FIG. 6, the second level finds \overline{D}ₗ(e) by using the values of \overline{D}ₗ₋₁(1), \overline{D}ₗ₋₁(2), . . . , \overline{D}ₗ₋₁(e−1), and the number of cases to be compared increases when the value of e increases.

That is, as can be known from Equation 6 and FIG. 5, the second level adds \tilde{D}(s, e) found by the first level to \overline{D}ₗ₋₁(e−1) by using (l−1) reference patterns and (s−1) matching costs, and finds the matching costs with the l reference patterns by using the dynamic programming scheme. The above-described algorithm is summarized below.

I. The First Stage (Initialization)
\overline{D}₀(0)=0, \overline{D}ₗ(0)=∞
1≦l≦Lₘₐₓ
\overline{D}₁(e)=\tilde{D}(1, e)
2≦e≦M

II. The Second Stage (Iterative Calculation)

$${\overline{D}}_{2} ( e ) = {min}_{1 \leq s < e} [ \tilde{D} ( s , e ) + {\overline{D}}_{1} ( s - 1 ) ] , 3 \leq e \leq M$$

$${\overline{D}}_{3} ( e ) = {min}_{1 \leq s < e} [ \tilde{D} ( s , e ) + {\overline{D}}_{2} ( s - 1 ) ] 4 \leq e \leq M$$

$${\overline{D}}_{l} ( e ) = {min}_{1 \leq s < e} [ \tilde{D} ( s , e ) + {\overline{D}}_{l - 1} ( s - 1 ) ] l + 1 \leq e \leq M$$

III. The Third Stage (Final Solution)

$${D}^{*} = {min}_{1 \leq l \leq {L}_{max}} [ {\overline{D}}_{l} ( M ) ]$$

That is, the final calculation D* represents the total matching costs, and the arrangement of words to be recognized in this instance is found by extracting the index of corresponding reference patterns from the traceback module 80.

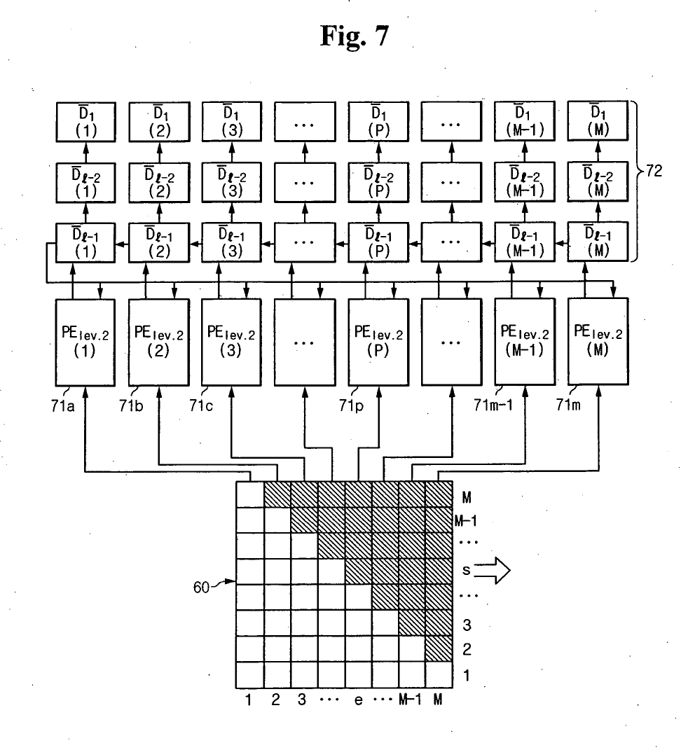

FIG. 7 shows a detailed configuration of the second level for performing the above-described algorithm according to an exemplary embodiment of the present invention. As shown in FIG. 7, the second level includes a second processing element group 70 having a plurality of processing elements 71a to 71m that have the same configuration for calculating the matching costs \overline{D}ₗ(e) with L reference patterns based on the minimum matching cost \tilde{D}(s, e) for one test pattern calculated by the first level, and a register 72 for storing the matching costs calculated by the respective processing elements. The second level is easy to design and modify since it has a plurality of processing elements having the same configuration in a like manner of the first level.

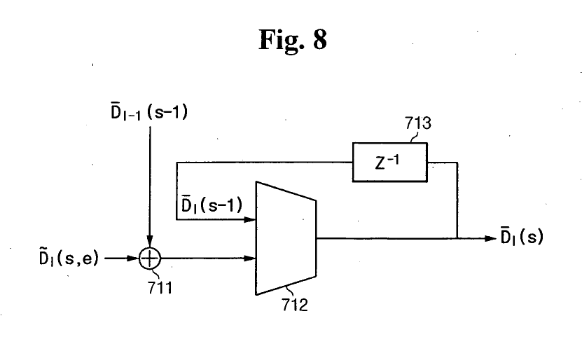

FIG. 8 shows a configuration of the processing elements 71a to 71m forming the second processing element group 70 of the second level. As shown in FIG. 8, the processing elements of the second level respectively include an adder 711 for receiving two inputs of \tilde{D}(s, e) and \overline{D}ₗ₋₁(s−1) from a memory module of the first level and adding the two inputs, a comparator 712 for comparing the value of \overline{D}ₗ(s) calculated by the adder 711 with an output value of \overline{D}ₗ(s−1) provided by a delay unit 713 and outputting a smaller value, and a delay unit 713 for delaying the output value of \overline{D}ₗ(s) provided by the comparator 712.

As shown in FIG. 7, the processing elements 71a to 71m of the second processing element group sequentially receive the value of \tilde{D}(s, e) from the memory module 60, and concurrently receive the value of \overline{D}ₗ₋₁(s−1) calculated and stored in the register 72. While M clock signals are applied, these two types of input values \tilde{D}(s, e) and \overline{D}₁₋₁(s−1), are transmitted to the processing elements 71a to 71m, the minimum one \overline{D}ₗ(s) is selected among the sums of the two inputs, and the value of \overline{D}ₗ(s) is output when the (M+1)th clock signal is applied. The output value of \overline{D}ₗ(s) is stored in the register, and the matching cost thereof with the (l+1)th reference pattern is calculated. That is, the processing elements 71a to 71m repeatedly calculate matching costs with the reference patterns during the M clock signals and provide update results to the register at the (M+1)th clock signal. When the above-described repetition process is performed on all the reference patterns Lₘₐₓ stored in the memory, the register stores all the values of \overline{D}ₗ(s), and finds the final matching cost described in the third stage by using all the values.

The traceback module 80 performs traceback on the reference patterns stored in the memory 42 by using the final matching cost \overline{D}ₗ(s), and extracts a corresponding reference index, thereby recognizing the speech signals provided to the speech recognition device according to the exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, hardwired realization of the hidden Markov model software for speech recognition allows faster speech recognition, increases speech recognition rates, and provides a speech recognition device for ASIC-based mass production.

Further, the present invention provides a small speech recognition device without requiring a software-driving computer to thus provide an easy installation of the same device to an apparatus that uses speech recognition, and allows high data rates, realization of a parallel structure, and real-time speech recognition. Therefore, the present invention is applicable to speech recognizable fields including home appliances, toys, mobile terminals, and PDAs.

What is claimed is:

1. A speech recognition device comprising:
an analog to digital (A/D) converter for sampling and quantizing speech signals into digital speech signals;
a noise eliminator for reducing noise from the digital speech signals;
a feature vector generator for generating a feature vector from the noise-eliminated speech signals, and converting the feature vector into a test pattern; and
a processor including a plurality of processing elements arranged in parallel, each processing element calculating a matching cost of a test pattern and a reference pattern, selecting the minimum value from among the calculated matching costs, and outputting the minimum value as the minimum matching cost of an input test pattern.

2. The speech recognition device of claim 1, wherein the processor comprises:
a memory module for storing a plurality of reference patterns corresponding to a plurality of words, and sequentially outputting characteristic vectors included in the reference patterns for calculating matching costs; and
a pattern match module including at least one processing element group having a plurality of processing elements arranged in parallel, calculating a minimum matching cost for a test pattern, and extracting an index of a corresponding reference pattern.

3. The speech recognition device of claim 2, wherein the pattern match module comprises:
a first processing element group including a plurality of processing elements arranged in parallel, establishing different start points for calculating matching points between test patterns and reference patterns, and calculating matching costs of the start points and end points;
a comparison module for determining the minimum matching cost from among the matching costs calculated by the first processing element group, extracting an index of a corresponding reference pattern from the memory module, and storing the index;
a second processing element group for finding a reference pattern that matches a test pattern of an input speech signal the most by using the minimum matching cost provided by the comparison module; and
a traceback module for tracing back the calculation result performed by the second processing element group, and extracting a corresponding index.

4. The speech recognition device of claim 3, wherein the matching cost in the first processing element group is given as:
$${PE}_{leυ 1} ( υ , s , e ) = {min}_{w ( m )} {\sum }_{m = s}^{e} ‖ \vec{t} ( m ) - {\vec{r}}_{υ} ( w ( m ) ) ‖$$
where w(m) is a window function, t(m) is a test pattern, rᵥ(m) is a v-th reference pattern, s is a start point of calculating the matching cost, e is an end point of calculating the matching cost, and m is the dimension of a total frame.

5. The speech recognition device of claim 3, wherein the comparison module comprises:
a comparator for comparing a matching cost that is input before a predetermined time and is stored with a matching cost input at a predetermined time, and outputting a smaller value; and
a memory controllable by the first in first out (FIFO) method and allowing sequential comparison on the input speech signals.

6. The speech recognition device of claim 3, wherein the processing element of the second processing element group comprises:
an adder for adding a minimum matching cost for I reference patterns of a test pattern determined by the first processing element group output by the comparison module and a minimum matching pattern for (I−1) reference patterns calculated and stored before the minimum matching cost for the I reference patterns is input;
a comparator for comparing an output value of the adder and a value generated by delaying the output value by the delay unit, and determining the smaller one; and
a delay unit for delaying the matching cost output by the comparator by one clock signal.

7. The speech recognition device of claim 3, wherein the second processing element group further comprises a register for storing the matching costs calculated by the processing elements in predetermined storage spaces.

8. The speech recognition device of claim 7, wherein the second processing element calculates matching costs with reference patterns during M clock signals, and updates a matching cost in the register at the (M+1)th clock signal.

9. A speech recognition device for finding a test pattern of a speech signal and a reference pattern having a minimum matching cost, comprising:
a feature vector generator for generating a feature vector from noise-eliminated speech signals, and converting the feature vector into a test pattern for speech recognition; and
a processor including a memory module for storing a plurality of reference patterns corresponding to a plurality of words and sequentially outputting the feature vector included in the reference patterns, and including a plurality of processing elements arranged in parallel each of which calculates a matching cost of a test pattern and a reference pattern, selects the minimum one from among the calculated matching costs, and outputs the minimum one as the minimum matching cost for a test pattern.
